(19) United States
(12) Patent Application Publication
(10) Pub. No.: US 2025/0104480 A1
(43) Pub. Date: Mar. 27, 2025

(54) METHOD AND SYSTEM FOR DETERMINING LIVENESS OF A SUBJECT

(71) Applicant: HYPERVERGE INC., Irving, TX (US)

(72) Inventors: Vignesh Krishnakumar, Chennai (IN); Hariprasad P S, Chennai (IN); R V N S Kalyan, Hyderabad (IN); Karthik Pullalarevu, Bangalore (IN); Yogeeshwar S, Chromepet (IN)

(73) Assignee: HYPERVERGE INC., Irving, TX (US)

(21) Appl. No.: 18/891,393

(22) Filed: Sep. 20, 2024

Related U.S. Application Data
(60) Provisional application No. 63/584,825, filed on Sep. 22, 2023.

(51) Int. Cl. G06V 40/40; G06V 10/72; G06V 10/80; G06V 10/82; G06V 20/40

(52) U.S. Cl. CPC G06V 40/40; G06V 10/811; G06V 10/82; G06V 20/40; G06V 10/72

(57) ABSTRACT

The present disclosure relates to a method and a system for determining liveness of a subject. The method encompasses receiving, from an image processing system, a final image liveness score. The method further comprises, receiving, from a video processing system, a video liveness score. The method further comprises, receiving, from a sensor-data processing system, a sensor-based liveness score. The method further comprises, analyzing, the final image liveness score, the video liveness score, and the sensor-based liveness score. The method further comprises, grouping, the final image liveness score, the video liveness score, and the sensor-based liveness score based on the analysis. The method further comprises, identifying, a set of liveness detection mechanisms based on the grouping. The method further comprises, determining, the liveness of the subject based on the set of liveness detection mechanisms.

### CROSS REFERENCE TO RELATED APPLICATION

This application claims the benefit under 35 U.S.C. § 119(e) of U.S. Provisional Patent Application No. 63/584,825, filed Sep. 22, 2023, the entire contents of which are incorporated herein by reference.

### FIELD OF THE INVENTION

The present disclosure generally relates to biometric authentication-based liveness detection. More particularly, the present disclosure relates to a method and a system for determining liveness of a subject.

### BACKGROUND OF THE DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as an admission of prior art.

As the world becomes increasingly interconnected and reliant on digital platforms, the specter of identity fraud looms ever larger. Identity fraud poses a significant threat to individuals, businesses, and governments alike, leading to financial losses, compromised security, and reputational damage. Therefore, there is a pressing need for advanced measures to combat this growing menace. One essential solution lies in the development and implementation of robust liveness detection systems. These systems are designed to differentiate between real human beings and sophisticated impersonation attempts using artificial means like deepfakes, photoshop, digitally altered, synthetic images or other forged materials. By accurately verifying the genuine presence of a live person during identity verification processes, liveness detection ensures the authenticity and integrity of digital interactions, reinforcing trust, and safeguarding against fraudulent activities. As technology continues to evolve, the adoption of a resilient liveness detection system becomes paramount in fortifying the digital landscape against the ever-evolving tactics employed by identity fraudsters.

Over the period, face recognition technology has become an essential part of modern security systems. However, there is a growing concern over the vulnerability of such systems to spoofing attacks. Spoofing attacks refer to attempts by an impostor to impersonate a genuine user by presenting a fake or manipulated face image or multiframe media to the system. To counter such attacks, several anti-spoofing systems have been developed, falling under two categories: active and passive liveness solutions. Active liveness solutions require the subject to perform a pre-determined activity or any random motion. These solutions rely on the action performed by the subject to determine the liveness of the subject such as user. For example, an active liveness system may ask the subject to blink or nod their head. Passive liveness solutions, on the other hand, determine the liveness of the subject based on the input captured without expecting the subject to perform any sort of activity. Passive liveness systems are more desirable in real-world scenarios as they are easy to use and reduce user inconvenience.

Further, the known existing active liveness solutions require the subjects to carry out a complex and elaborate set of tasks, affecting the system's overall usability and making it difficult to be carried out for someone inexperienced with the procedure. Therefore, there is a need for more accessible and user-friendly passive liveness solutions. The most of the existing passive liveness solutions rely on depth information from stereovision cameras, infra-red readings from an IR sensor, photoplethysmography sensor, etc. Dependency on such sensors results in hardware constraints and would require a custom hardware setup for the system to be used. Such systems, therefore, cannot be implemented in a wide variety of day-to-day life electronic devices such as mobile phones, tablets etc. However, passive liveness systems relying on image or multiframe media information from cameras and other standard sensors such as accelerometers and gyroscopes, which are found by default in the electronic devices such as mobile phones, can be more accessible and easily consumed in the form of mobile or web applications. Further, few of the known approaches use only a specific portion of information from the captured image or multiframe media, such as corneal reflection, reflection from artificially induced illumination patterns, etc. This can cause such systems to be sensitive and less robust to the environment where the input is captured. Several external factors, such as the background of the subject illumination conditions, can affect the performance of the liveness detection system. Further, several existing approaches use a face detection module to crop out the face region from the input image or multiframe media and only use the specific face region to analyse the liveness. In the case of certain non-live attacks, such as presentation attacks on different display devices, print attacks, and mask-based attacks, apparent clues such as reflection, random text, borders, etc. will be lost if only the face region is used. Furthermore, some of the existing systems that determine liveness by combining one or more modalities exist, but the problem with such approaches is that the network or group of networks are trained end-to-end to determine liveness. This approach would, therefore, require data points across all modalities for each instance, making training of such networks tedious and requiring a lot of effort concerning data collection. Moreover, none of the existing passive liveness approaches collectively uses multiple modalities of data, such as image, multiframe media, and sensor information from the accelerometer and gyroscope.

Therefore, there are a number of limitations to the existing solutions and in order to overcome these and such other limitations of the known solutions it is necessary to provide an efficient solution for comprehensive multi-modal liveness detection.

### SUMMARY

This section is provided to introduce certain aspects of the present disclosure in a simplified form that are further described below in the detailed description. This summary is not intended to identify the key features or the scope of the claimed subject matter.

An aspect of the present disclosure may relate to a method for determining liveness of a subject. The method comprises receiving, by a receiving unit from an image processing system, a final image liveness score. The method further comprises, receiving, by the receiving unit from a video processing system, a video liveness score. The method further comprises, receiving, by the receiving unit from a sensor-data processing system, a sensor-based liveness score. The method further comprises, analyzing, by a decision unit, the final image liveness score, the video liveness score, and the sensor-based liveness score. The method further comprises, grouping, by the decision unit, the final image liveness score, the video liveness score, and the sensor-based liveness score based on the analysis. The method further comprises, identifying, by the decision unit, a set of liveness detection mechanisms based on the grouping. The method further comprises, determining, by a determination unit, the liveness of the subject based on the set of liveness detection mechanisms.

Another aspect of the present disclosure may relate to a system for determining liveness of a subject. The system comprises a receiving unit that is configured to receive from an image processing system, a final image liveness score. The receiving unit is further configured to receive from a video processing system, a video liveness score. Also, the receiving unit is configured to receive from a sensor-data processing system, a sensor-based liveness score. The system further comprises a decision unit that is configured to analyze the final image liveness score, the video liveness score, and the sensor-based liveness score. The decision unit is then configured to group the final image liveness score, the video liveness score, and the sensor-based liveness score based on the analysis. Also, the decision unit is configured to identify, a set of liveness detection mechanisms based on the grouping. The system further comprises a determination unit that is configured to determine the liveness of the subject based on the set of liveness detection mechanisms.

### OBJECTS OF THE DISCLOSURE

This section is provided to introduce certain non-limiting objects of the present disclosure.

In order to overcome at least a few problems associated with the known solutions as provided in the previous section, an object of the present disclosure is to substantially reduce the limitations and drawbacks of the prior known solutions as described hereinabove.

An object of the present disclosure is to provide a solution for comprehensive multi-modal liveness detection and to efficiently detect a fraudulent action.

Another object of the present disclosure is to provide a truly passive comprehensive multi-modal liveness detection system to efficiently detect a fraudulent action.

Another object of the present disclosure is to provide a passive liveness detection system that can be used on any device with a camera, such as mobile devices, computers, and edge devices, making it accessible and user-friendly for a broad range of users.

Yet another object of the present disclosure is to provide a solution that uses multiple types of data inputs, including images, videos, and sensor data, to determine liveness, resulting in a more robust and accurate detection system.

Yet another object of the present disclosure is to provide a solution for an easy-to-integrate SDK for input capture for liveness detection that further allows the existing developers to integrate the solution into their existing applications.

Yet another object of the present disclosure is to provide a solution that is compatible with a mobile or web application, providing a user-friendly interface for end-users to interact with the liveness detection system.

### BRIEF DESCRIPTION OF DRAWINGS

The accompanying drawings, which are incorporated herein, constitute a part of this disclosure. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components or circuitry commonly used to implement such components. Although exemplary connections between sub-components have been shown in the accompanying drawings, it will be appreciated by those skilled in the art that other connections may also be possible, without departing from the scope of the disclosure. All sub-components within a component may be connected to each other, unless otherwise indicated.

FIG. 1 illustrates an exemplary system for determining liveness of a subject, in accordance with exemplary embodiments of the present invention.

FIG. 2 illustrates an exemplary method for determining liveness of a subject, in accordance with exemplary embodiments of the present invention.

The foregoing shall be more apparent from a more detailed description of the invention below.

### DETAILED DESCRIPTION OF THE DISCLOSURE

In the following description, for the purposes of explanation, various specific details are set forth in order to provide a thorough understanding of the embodiments of the present invention. It will be apparent, however, that embodiments of the present invention may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present invention are described below, as illustrated in various drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

A “processor” or “processing unit” refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required to perform the functions as disclosed in the present disclosure.

The present disclosure relates to methods and systems for determining liveness of a subject. More particularly, the methods and systems of the present invention relate to a comprehensive multi-modal liveness detection. Specifically, the present invention pertains to a passive liveness detection system that is designed to prevent spoofing in facial recognition and authenticity verification. The present invention therefore provides a solution designed to detect spoofing in facial recognition and to facilitate authenticity verification of a user.

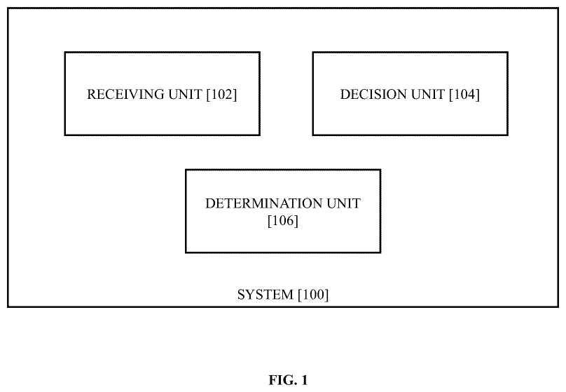

Referring to FIG. 1, an exemplary block diagram of a system [100] for determining liveness of a subject, in accordance with exemplary embodiments of the present invention is illustrated. The system [100] comprises at least one receiving unit [102], at least one decision unit [104], and at least one determination unit [106]. Also, all of the components/units of the system [100] are assumed to be connected to each other unless otherwise indicated below. Also, in FIG. 1 only a few units are shown, however, the system [100] may comprise multiple such units, or the system [100] may comprise any such numbers of said units, as required to implement the features of the present disclosure. Also, it is pertinent to note that the system [100] is exemplary and the system [100] may work in conjunction with, one or more modules/units as required and/or as obvious to a person skilled in the art, to implement the features of the present disclosure.

The system [100] is configured for determining liveness of a subject with the help of the interconnection between the components/units of the system [100]. The subject (or referred herein as “user”) as disclosed in the present disclosure may be a person whose identity is required to be verified in various use cases such as while applying any application for banking purpose etc.

Further, to determine the liveness of the subject, one or more images and one or more videos (may be referred herein as multi-frame media) from an electronic device such as a mobile phone, a tablet, etc. are captured. The electronic device to capture the one or more images and the one or more videos, may present a capture button and a capture screen to the user of the electronic device, consisting of an area where a camera feed is displayed. Furthermore, in an exemplary implementation of the present solution, an orientation check associated with the electronic device may be performed in order to ensure that the electronic device is held vertically with respect to the user before the capture button is enabled in order to facilitate capturing a camera feed via the electronic device.

In a preferred implementation of the present solution, the captured camera feed is processed by a face detector unit which may be a lightweight face detector to detect one or more faces in the camera feed. It would be appreciated by a person skilled in the art that the face detector unit is not limited to the lightweight face detector, and another type of the face detector unit may be considered depending on a use case. In another implementation of the present disclosure, the capture button is enabled only in a scenario where at least one face of an appropriate size is detected at the capture screen presented to the user of the electronic device. Further, in a scenario where at least one face of the appropriate size is detected, the capture button is enabled, and the camera feed of the user is captured. The camera feed of the user comprises capturing at least a frame associated with the image of the user, one or more previous frames associated with the image of the user, and one or more sensor data associated with the frame via an accelerometer sensor, a gyroscope sensor and such other sensor(s) associated with the electronic device. The frame associated with the image of the user hereinafter may also referred as a selfie image of the user. In an exemplary implementation of the present solution, the one or more previous frames associated with the image of the user may comprise a set of frames up to 1 second prior to the frame associated with the image of the user, for e.g., if the frame associated with the image of the user is captured at time T3 then the one or more previous frames may comprise a set of frames up to 1 second prior to the frame associated with the image of the user that is the set of frames between T1 and T3−1 sec based on the camera feed. In another exemplary implementation of the present solution, the one or more previous frames associated with the image of the user may comprise the set of frames that is at least 3 seconds prior to the frame associated with the image of the user. It is to be noted that time for capturing the one or more previous frames as disclosed herein may be either a preconfigured time or a dynamically defined time, as deemed appropriate for the implementation of the present solution. It should also be noted that the specific exemplary implementations mentioned, wherein the one or more previous frames associated with the image of the user are described as being at least 1 second or 3 seconds prior to the frame associated with the image of the user, are provided solely for illustrative purposes. These examples are not intended to limit the scope of the invention in any way. The invention encompasses various time intervals for capturing previous frames, and the embodiments mentioned are not exhaustive. The scope of the invention is defined by the claims and their equivalents, rather than the specific exemplary implementations described.

In an implementation of the present solution, the user may be presented with a preview screen to review the camera feed of the user. In a preferred implementation of the present solution, one or more frame checks and one or more heuristic checks may be performed on the camera feed of the user. In an implementation of the present invention, at least one of the one or more frame checks and the one or more heuristic checks is performed on the camera feed of the user to detect any subtle differences in consecutive frames of the camera feed of the user and to thereby detect any attempts of image injection in the camera feed of the user. In an exemplary implementation of the present solution, the camera feed of the user may be further processed to determine the liveness of the user, and to perform an end-to-end user signature verification and an end-to-end user signature encryption to prevent any fraudulent attack such as a man-in-the-middle attacks, and also to ensure the integrity of the input captured.

Once the camera feed of the user is captured, one or more sanity checks may be performed. The one or more sanity checks may be performed on at least a part of the camera feed of the user, such as the frame associated with the image of the user (i.e., the image of the subject), the one or more previous frames associated with the image of the user (the one or more previous frames combined with the frame associated with the image hereinafter also referred as a multi-frame media or the video of the user), and one or more sensor data associated with the frame captured via sensors such as the accelerometer sensor and the gyroscope sensor associated with the electronic device. It is to be noted that the one or more sanity checks on at least the part of the camera feed of the user may be conducted in various ways, including but not limited to concurrent execution of at least the part of the camera feed by one or more units to facilitate the image and/or the video capturing, sequential execution of at least the part of the camera feed by a specialized unit to facilitate the image and/or the video capturing, or any other method that may be apparent to a person skilled in the relevant field. The disclosure of the solution herein, which encompasses performing the one or more sanity checks on at least the part of the camera feed of the user, should not be construed as imposing restrictions on the manner in which these sanity checks are performed.

In a preferred implementation of the present solution, in order to perform the one or more sanity checks on the camera feed of the user, a rotational invariant face detector is run via the face detector unit through the selfie image of the user to identify one or more faces present in the selfie image. In an exemplary implementation of the present solution, the one or more sanity checks on the camera feed of the user may also encompasses identification of the one or more faces present in the selfie image based on coordinates that form a bounding box around the one or more faces in the selfie image, one or more fiducial points of the one or more faces in the selfie image. The one or more fiducial points may be determined based on a location of a left eye associated with each face in the selfie image, a location of the right eye associated with each face in the selfie image, a location of the nose associated with each face in the selfie image, a location of the right corner of the lips associated with each face in the selfie image, a location of the left corner of lips associated with each face in the selfie image, and an angle of inclination of the one or more faces in the selfie image. Further, in an implementation if no face is identified in the image, the user may be prompted to recapture the camera feed. Furthermore, in another implementation if multiple faces are detected in the image, the user may be prompted to recapture the camera feed.

Further, in another exemplary implementation of the present solution, the one or more sanity checks on the camera feed of the user may also encompass performing a quality analysis for the selfie image which may be further performed via a neural network-based image quality assessment module, wherein the quality analysis of the image is performed to detect at least one of an image blur issue, an image overexposure issue, an image underexposure issue, an image brightness issue and a lack of illumination issue in an image.

Further, in another exemplary implementation of the present solution, the one or more sanity checks on the camera feed of the user may also encompass performing a face posture check via a neural network to compute a face roll analysis, a face yaw analysis, and a face pitch analysis to understand the position of the face in the image. Further, in another exemplary implementation of the present solution, an eyes region of the face in the image is cropped out, to detect state of eyes of the face in the image i.e., if the eyes are open or eyes are closed via a convolution neural network-based classifier. Furthermore, a presence of any obstruction such as eyeglasses or sunglasses on the face in the image may also be detected via a convolution neural network-based object detector, and the presence of a face mask on the face in the image is checked using the convolution network-based classifier.

Furthermore, in another implementation of the present solution, the one or more sanity checks on the camera feed of the user may also encompass one or more image manipulation checks performed via one or more convolution network-based models for the selfie image of the user and the multi-frame media of the user to detect at least a face occlusion and an image manipulation. Further in an implementation of the present solution, to detect at least the face occlusion, the selfie image of the user and the multi-frame media of the user may be passed through a convolutional network-based occlusion detection module, as the face of the user may be occluded e.g. with hands or other objects and hence the selfie image of the user in such scenario and the multi-frame media of the user in such scenario may not be optimal to determine the liveness of the user. Thus, the occlusion check ensures that the face of the user is visible and consistent in all the multi-frame media of the user, including the image of the user.

Further, in an event the face is occluded, the input image/selfie image is rejected, and the user may be asked to retake the input image.

Furthermore, in another implementation of the present solution, the image of the user and the one or more frames from the multi-frame media of the user may be checked based on the one or more image manipulation checks performed via the one or more convolution network-based modules for an image manipulation, such as photoshop edits or deep fakes. The captured selfie image of the user and the multi-frame media of the user may be passed through the convolution network-based deep fake classifier and image manipulation detectors in order to perform the one or more image manipulation checks, such as to detect any image manipulation(s) for e.g., a photoshop edit manipulation or a deep fake manipulation. Further, the one or more image manipulation checks may also be configured to successfully detect and reject synthetic images and the multi-frame media submitted through camera feed hijacking.

Thereafter, in another implementation of the present solution, the one or more sanity checks on the camera feed of the user may also comprise one or more sensor reading checks. The one or more sensor reading checks is performed based on a sensor data captured via the sensors such as the accelerometer sensor and the gyroscope sensor of the electronic device. In an implementation, the one or more sensor reading checks are performed to ensure the collected data associated with the sensors e.g., the accelerometer sensor and the gyroscope sensor is consistent and is properly formatted. As used herein the mention of sensor readings/data, such as those obtained from the accelerometer sensor and the gyroscope sensor of the electronic device, should not be considered as a limitation and other sensor data appreciated by a person skilled in the art may be considered depending on a use case. It is important to note that the use of these specific sensors is exemplary in nature and does not limit the scope of the present disclosure. Other sensor readings/data from the electronic device may also be utilized to implement the solution described herein. The invention encompasses the utilization of any suitable sensor readings/data available on the electronic device, whether explicitly mentioned in this specification or not. The scope of the present disclosure shall not be limited in light of the same and shall be interpreted to encompass any and all of their equivalents, encompassing the incorporation of various sensor readings/data to achieve the desired functionalities, as evident to those skilled in the art. Further, it should also be noted that the terms “sensor reading” and “sensor data” are used interchangeably in the present disclosure to refer to the information and measurements obtained from various sensors of the electronic device. The interchangeable usage of these terms is solely for the purpose of clarity and does not imply any distinction or limitation in their meanings within the context of this disclosure. The terms are intended to be synonymous and inclusive of all relevant data collected from sensors, whether they are the accelerometers, the gyroscopes, or any other sensing components present in the electronic device. The scope of the present disclosure as disclosed herein encompasses the broad utilization of sensor readings and sensor data interchangeably to implement the various aspects and embodiments of the disclosed solution.

Once the camera feed is captured and the one or more sanity checks are performed, the receiving unit [102] then receives from an image processing system, a final image liveness score. The image processing system is configured to generate the final image liveness score based on a performance of an image-based liveness detection on the image of the subject. In an implementation, the image processing system may comprise a neural network-based rotation-invariant face detector. The neural network-based rotation-invariant face detector may detect the one or more fiducial points on the face in the image along with the face bounding box. Furthermore, the one or more fiducial points on the face comprises five fiducial points on the face.

Continuing further, in an implementation, the neural network-based rotation-invariant face detector may detect one or more fiducial points (i.e., the five fiducial points) on the face corresponding to the left eye, the right eye, the nose, the left corner of the lips, and the right corner of the lips along with the face bounding box. Further, in an event if no face is detected in the captured image the user may be prompted to recapture the image. Further, in another event if more than one face is detected in the captured image, the largest face from the detected faces is selected based on an area of bounding boxes. Furthermore, the face fiducial point(s) of the largest face detected in the captured image are used to align and crop the face in such a way that the line between the eyes is horizontal and the face is rescaled to a pre-defined fixed size. The face may be then wrapped such that the detected fiducial points fall as close as possible to a predefined position of the face crop.

Continuing further, in another implementation the neural network-based rotation-invariant face detector may detect and may localize the face in the image, providing pixel coordinates that form the bounding box around the face. The neural network-based rotation-invariant face detector may create plurality of images from the original image using the said face coordinates. The plurality of images comprises a first image with only the face, a second image with the face and a first pre-defined percentage of background (e.g., 50% background), and a third image with the face and a second pre-defined percentage of background (e.g., 100% background). In an implementation, the said plurality of images are resized to a standard size of 224×224 pixels. It would be appreciated by a person skilled in the art that the pre-determined size is not limited to the 224×224 pixels, and the size may be considered depending on a use case. Further, a monocular depth estimation unit may generate plurality of depth maps corresponding to each image from the plurality of images. As would be understood, generally the depth map is an image or image channel that contains information relating to the distance of the surfaces of scene objects from a viewpoint.

Continuing further, a plurality of modified images may be created based on the addition of the depth map and a set of color models associated with the plurality of images. The set of color models comprises a Hue, Saturation, Value (HSV) color model, a Luminance, Chrominance (YCbCr) color model and a Red, Green, Blue (RGB) color model. Additionally, the HSV color model and the YCbCr color model are computed from the RGB (Red Green Blue) Color model. Therefore, the final model input (i.e., the plurality of modified images) is created by adding the depth map, HSV and YCbCr images to the RGB image as a subsequent channel.

Also, each modified image from the plurality of modified images comprises a set of channels. In an implementation the plurality of modified images includes three images, and the set of channels of each modified image includes 10 channels. It would be appreciated by a person skilled in the art that a number of channels in the set of channels is not limited to 10, and its value may be considered depending on a use case.

Continuing further, said plurality of modified images is provided to a plurality of multi-branch image liveness models. Also, each multi-branch image liveness model from the plurality of multi-branch image liveness models receives the plurality of modified images in one of a simultaneous manner and one at a time manner. Further, each multi-branch image liveness model from the plurality of multi-branch image liveness models is a neural network-based model, and the said each multi-branch image liveness model is trained for detecting a specific type of non-live attack. The specific type of non-live attack is one of a display attack type, a print attack type, and a mask-based attack type. The display attack type is a type of digital attack (or referred herein as display attack) where a display configuration is tweaked with an intention of a display fraud. The print attack type is a type of digital attack (or referred herein as print attack) where a configuration of an image is tweaked with intention of a print related fraud. The mask attack type is a type of digital attack (or referred herein as mask attack) where a configuration of an image is masked with an intention of a masking related fraud. Moreover, the said plurality of modified images (for instance as mentioned above the three images) are fed to a plurality of multi-branch image liveness models (e.g., three multi-branch image liveness models), which are capable of taking the plurality of modified images (e.g., the three images) as input simultaneously.

Each of the three convolutional neural networks is trained to detect a specific type of attack. The first neural network detects display attacks, the second neural network detects a print attacks, and the third neural network detects a two dimensional (2D) and/or a three dimensional (3D) mask attack. The ensemble of the three models may determine the final output of the module, with the image being considered live only when all three networks vote for it. Thereafter, the final liveness score is given by combining the collective liveness scores of the three models. This final liveness score is then received at the receiving unit [102].

Continuing further, the receiving unit [102] also receives from a video processing system a video liveness score. The video processing system is configured to generate the video liveness score based on a performance of a video-based liveness detection on the video of the subject/user. In an implementation the video of the user is validated based on one or more quality checks, one or more compliance checks and pre-processing of the video, for video liveness inference.

Continuing further, in an implementation the video is pre-processed to prepare an input, for the video processing system, to detect the video-based liveness. Further, the video processing system, to pre-process the video, may sample a plurality of consecutive frames from the video of the user. In a preferred implementation, the plurality of frames involves seventeen consecutive frames.

Continuing further, the video processing system may generate a set of optic flow images. The video processing system, to generate the set of optic flow images, may pair two consecutive frames from the plurality of frames (e.g., the seventeen consecutive frames). Further, the video processing system may run the paired frames on an optic flow model. In the above-mentioned preferred implementation, the set of optic flow images, generated by the video processing system, comprises sixteen images.

Also, generally the optical flow model is a computer vision technique that estimates the motion of objects (i.e., the subject in the present disclosure) in a video sequence. It involves analyzing the changes in intensity patterns of pixels over time to determine the direction and magnitude of object motion. Optical flow may be used in various applications such as video stabilization, object tracking, and action recognition. The optical flow model works by assuming that the movement of the object may be represented as a dense vector field, where each vector represents a displacement of a pixel from one frame to the next. An optical flow technique estimates this vector field by computing the displacement of pixels between adjacent frames.

Continuing further, the last “n” of the plurality of frames (e.g., in the above-mentioned preferred implementation last sixteen of the seventeen consecutive frames), along with the generated set of optic flow images (e.g., the sixteen optic flow images), are all resized to 224×224 for input to the video processing system (or referred herein as video liveness model). It would be appreciated by a person skilled in the art that the pre-determined size is not limited to the 224×224 pixels, and its value may be considered depending on a use case.

The video liveness model comprises a multi-branch video liveness model. Continuing further, in the video liveness model, a set of consecutive RGB images (i.e., the last “n” of the plurality of frames) are used as an input for a first branch of the multi-branch video liveness model, while their corresponding optic flow images are used as an input for a second branch of the multi-branch video liveness model. Therefore, in the above preferred implementation, the sixteen consecutive RGB images are used as input for the first branch of the multi-branch video liveness model, while their corresponding optic flow images are used as an input for the second branch of the multi-branch video liveness model.

The multi-branch video liveness model thereafter generates the video liveness score based on a processing of the set of consecutive RGB images and the set of optic flow images. More specifically, for generating the video liveness score, the multi-branch video liveness model is trained to detect a movement of a target subject in a target video in an event of one of presence of a set of non-live attacks in said target video and an absence of the set of non-live attacks in said target video. The set of non-live attacks comprises at least one of the one or more display attacks, the one or more print attacks, and the one or more mask-based attacks. A person skilled in the art would appreciate that the set of non-live attacks as mentioned herein is not limited and any include other such similar type of attacks.

Further, the processing of the set of consecutive RGB images and the set of optic flow images comprises detecting a movement of the subject in the video. Further, the multi-branch video liveness model is further trained to generate a target video liveness score based on the movement of the target subject in the target video. Therefore, the multi-branch video liveness model initially processes the set of consecutive RGB images and the set of optic flow images to determine a movement of the subject based on the presence and/or absence of one or more non-live attacks. Once the movement of the subject is determined then the multi-branch video liveness model generates the video liveness score based on such determined movement. The generated video liveness score indicates the liveness or the non-liveness the subject, where the non-liveness of the subject indicates a fraudulent action on the video. This video liveness score is received at the receiving unit [102].

Continuing further, the receiving unit [102] also receives from a sensor-data processing system a sensor-based liveness score. The sensor-data processing system generates the sensor-based liveness score based on a receipt of a sensor data from a set of sensors for a predefined time duration. Further, the set of sensors may include, but not limited to, one or more accelerometer sensors and one or more gyroscope sensors. In an implementation, the sensor-data processing system may utilize the accelerometer sensor data (such as, but not limited to, data linear velocity of the electronic device, orientation of the electronic device, etc.) and the gyroscope sensor data (such as, but not limited to, data related to an angular velocity of the device, orientation of the device, etc.) to determine the liveness of the user. Further, in an implementation where the sensor-data processing system is configured along with the image processing system for liveness detection, the relative position and motion of the device may be used to distinguish between a live image(s) and a non-live image(s).

Furthermore, once the sensor data is received, the sensor-data processing system performs a set of sanity checks on the sensor data to generate a target sensor data. The target sensor data generated after performing the sanity check(s) on the sensor data may include a reliable, and an accurate data related to the orientation, movement and stability of the device. Considering an example, the accelerometer sensor data may include data related to the forward and/or backward movement of the device, whereas the gyroscope sensor data may include data related to the rotation of the device. The target data after the sanity check may include data that may focus on the subject and may remove any unwanted noise in the background.

Further, the sensor-data processing system performs normalization on the target sensor data to generate a normalized sensor data. The normalization of the target sensor data may include reorganizing the target sensor data and making it compatible to be utilized by the system [100]. For instance, the accelerometer sensor data and the gyroscope sensor data are normalized for easy processing. Furthermore, during the normalization of the target sensor data one or more anomalies and one or more extreme readings are removed.

Thereafter, the sensor-data processing system samples a set of data points from the normalized sensor data. In an implementation, the set of data points may include the last 250 sensor data logs, and the sensor data is logged approximately every ten milliseconds. Furthermore, in this implementation, the set of data points sampled may represent a recorded 2.5-3 seconds of sensor data, which is then provided as the input to a Convolutional Neural Network (CNN)-Long Short-Term Memory (LSTM) based model.

Therefore, the sampled set of data points is provided to the Convolutional Neural Network (CNN)-Long Short-Term Memory (LSTM) based model. Further, the CNN-LSTM model generates the sensor-based liveness score based on the set of data points, sampled from the normalized sensor data, for classifying a specific subject as one of a live specific subject and a non-live specific subject based on a set threshold. The set threshold is a pre-configured threshold indicating a liveness or non-liveness of a specific subject, and its value may be based on a use case or a requirement. A sensor-based liveness score determined for a subject is therefore compared with a set threshold to determine liveness or non-liveness of said subject. The sensor-based liveness score generated by the sensor-data processing system is then received at the receiving unit [102].

After receiving the final image liveness score, the video liveness score, and the sensor-based liveness score, the decision unit [104] is configured to analyze the final image liveness score, the video liveness score, and the sensor-based liveness score. More specifically, the final image liveness score, the video liveness score, and the sensor-based liveness score are analyzed to determine a set of ensembling techniques that may be implemented to group at least two of the final image liveness score, the video liveness score, and the sensor-based liveness score. For example, an ensembling technique may include considering feature vectors corresponding to each of the final image liveness score, the video liveness score, and the sensor-based liveness score for combining these scores.

The decision unit [104] is then configured to group the final image liveness score, the video liveness score, and the sensor-based liveness score based on the analysis. For instance, the decision unit [104] determines a set of combinations of the final image liveness score, the video liveness score, and the sensor-based liveness score based on the set of ensembling techniques. The set of combinations indicates one or more combinations of these scores that may be considered for determining a set of liveness detection mechanisms.

Thereafter, the decision unit [104] is configured to identify the set of liveness detection mechanisms based on the grouping. The set of liveness detection mechanisms comprises at least one of a voting-based mechanism, a weighted average based mechanism, and an auxiliary network-based mechanism. The determination unit [106] thereafter determines the liveness of the subject based on the set of liveness detection mechanisms.

More specifically, the determination unit [106], to determine the liveness of the subject based on the voting-based mechanism, is configured to compare the final image liveness score, the video liveness score, and the sensor-based liveness score with a corresponding pre-defined threshold score. After said comparison the determination unit [106] is configured to determine the subject as a live subject in an event each of the final image liveness score, the video liveness score, and the sensor-based liveness score is greater than the corresponding pre-defined threshold score. More specifically, in the voting-based mechanism, a user image is rejected as non-live if at least one of the liveness systems i.e., the image processing system, the video processing system, and the sensor-data processing system predicts the user image as a non-live image. Therefore, the voting-based mechanism is suitable for use cases where recall is critical.

Also, the determination unit [106], to determine the liveness of the subject based on the weighted average based mechanism, is configured to determine, a final liveness score based on a weighted average of each of the final image liveness score, the video liveness score, and the sensor-based liveness score. After determining the final liveness score the determination unit [106] is configured to determine the subject as a live subject in an event the final liveness score is greater than a preset threshold score. More specifically, in the weighted average based mechanism, predicted liveness scores of the liveness systems i.e., the image processing system, the video processing system, and the sensor-data processing system are averaged to determine a final liveness score. The weighted average based mechanism therefore reduces the false rejection rate.

Additionally, the determination unit [106], to determine the liveness of the subject based on the auxiliary network-based mechanism, is configured to provide, to a neural network-based model, at least one of the final image liveness score, the video liveness score, and the sensor-based liveness score. After providing these scores to the neural network-based model, the neural network-based model is configured to determine the subject as one of a live subject and a non-live subject based on at least one of the final image liveness score, the video liveness score, and the sensor-based liveness score. The neural network-based model is trained based on a set of final image liveness scores, a set of video liveness scores, and a set of sensor-based liveness score, to determine a target subject in a target video as one of a live target subject and a non-live target subject. Also, the neural network-based model is trained using one or more supervised learning techniques. More specifically, in the auxiliary network-based mechanism the neural network-based model is trained using a supervised learning on a set of feature vectors given out by the three liveness systems i.e., the image processing system, the video processing system, and the sensor-data processing system. The neural network-based model learns to identify exceptions, outliers, and general patterns to predict more robust and accurate liveness of the subject.

The system [100] therefore utilizes the liveness scores received from the image processing system, the video processing system, and the sensor-data processing system, for determining the liveness of the subject. Therefore, as the system [100] utilizes several liveness detection systems in conjunction, the liveness of the subject determined by the system [100] is more accurate as compared to the existing systems of liveness detection.

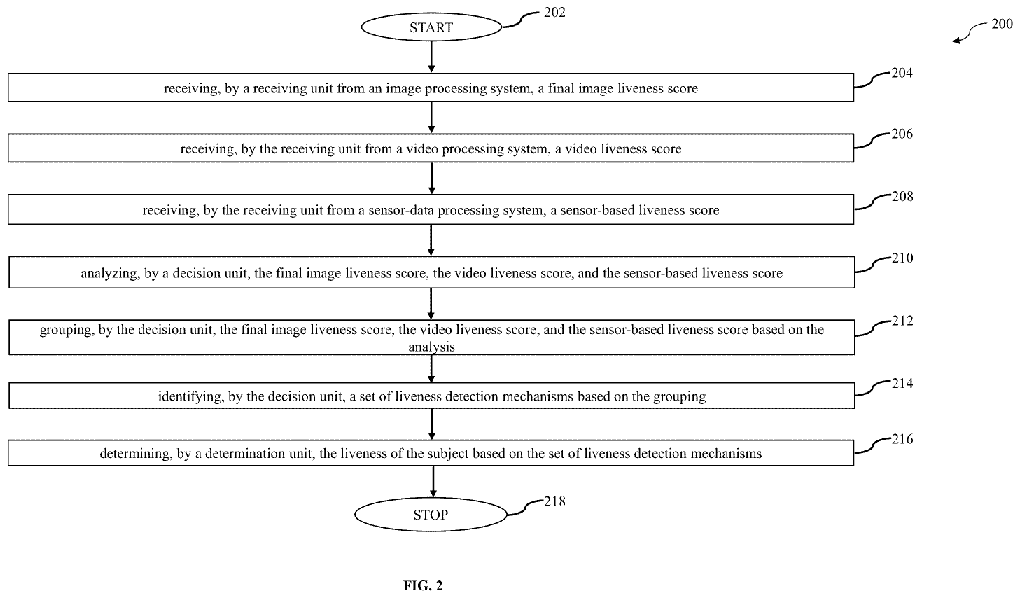

Referring to FIG. 2, an exemplary method [200] for determining liveness of a subject, in accordance with exemplary embodiments of the present invention, is illustrated. In an implementation, the method [200] is performed by the system [100]. As shown in FIG. 2, the method [200] begins at step [202].

At step [204], the method [200] comprises, receiving, by the receiving unit [102] from an image processing system, a final image liveness score. The image processing system generates the final image liveness score based on a performance of an image-based liveness detection on the image of the subject. In an implementation, the image processing system may comprise a neural network-based rotation-invariant face detector. The neural network-based rotation-invariant face detector may detect the one or more fiducial points on the face in the image along with the face bounding box. Furthermore, the one or more fiducial points on the face comprises five fiducial points on the face.

Continuing further, in an implementation, the neural network-based rotation-invariant face detector may detect one or more fiducial points (i.e., the five fiducial points) on the face corresponding to the left eye, the right eye, the nose, the left corner of the lips, and the right corner of the lips along with the face bounding box. Further, in an event if no face is detected in the captured image the user may be prompted to recapture the image. Further, in another event if more than one face is detected in the captured image, the largest face from the detected faces is selected based on an area of bounding boxes. Furthermore, the face fiducial point(s) of the largest face detected in the captured image are used to align and crop the face in such a way that the line between the eyes is horizontal and the face is rescaled to a pre-defined fixed size. The face may be then wrapped such that the detected fiducial points fall as close as possible to a predefined position of the face crop.

Continuing further, in another implementation the neural network-based rotation-invariant face detector may detect and may localize the face in the image, providing pixel coordinates that form the bounding box around the face. The neural network-based rotation-invariant face detector may create plurality of images from the original image using the said face coordinates. The plurality of images comprises a first image with only the face, a second image with the face and a first pre-defined percentage of background (e.g., 50% background), and a third image with the face and a second pre-defined percentage of background (e.g., 100% background). In an implementation, the said plurality of images are resized to a standard size of 224×224 pixels. It would be appreciated by a person skilled in the art that the pre-determined size is not limited to the 224×224 pixels, and the size may be considered depending on a use case. Further, a monocular depth estimation unit may generate plurality of depth maps corresponding to each image from the plurality of images. As would be understood, generally the depth map is an image or image channel that contains information relating to the distance of the surfaces of scene objects from a viewpoint.

Continuing further, a plurality of modified images may be created based on the addition of the depth map and a set of color models associated with the plurality of images. The set of color models comprises a Hue, Saturation, Value (HSV) color model, a Luminance, Chrominance (YCbCr) color model and a Red, Green, Blue (RGB) color model. Additionally, the HSV color model and the YCbCr color model are computed from the RGB (Red Green Blue) Color model. Therefore, the final model input (i.e., the plurality of modified images) is created by adding the depth map, HSV and YCbCr images to the RGB image as a subsequent channel.

Also, each modified image from the plurality of modified images comprises a set of channels. In an implementation the plurality of modified images includes three images, and the set of channels of each modified image includes 10 channels. It would be appreciated by a person skilled in the art that a number of channels in the set of channels is not limited to 10, and their value may be considered depending on a use case.

Continuing further, said plurality of modified images is provided to a plurality of multi-branch image liveness models. Also, each multi-branch image liveness model from the plurality of multi-branch image liveness models receives the plurality of modified images in one of a simultaneous manner and one at a time manner. Further, each multi-branch image liveness model from the plurality of multi-branch image liveness models is a neural network-based model, and the said each multi-branch image liveness model is trained for detecting a specific type of non-live attack. The specific type of non-live attack is one of a display attack type, a print attack type, and a mask-based attack type. The display attack type is a type of digital attack (or referred herein as display attack) where a display configuration is tweaked with an intention of a display fraud. The print attack type is a type of digital attack (or referred herein as print attack) where a configuration of an image is tweaked with intention of a print related fraud. The mask attack type is a type of digital attack (or referred herein as mask attack) where a configuration of an image is masked with an intention of a masking related fraud. Moreover, the said plurality of modified images (for instance as mentioned above the three images) are fed to a plurality of multi-branch image liveness models (e.g., three multi-branch image liveness models), which are capable of taking the plurality of modified images (e.g., the three images) as input simultaneously.

Each of the three convolutional neural networks is trained to detect a specific type of attack. The first neural network detects display attacks, the second neural network detects a print attack, and the third neural network detects a two dimensional (2D) and/or a three dimensional (3D) mask attack. The ensemble of the three models may determine the final output of the module, with the image being considered live only when all three networks vote for it. Thereafter, the final liveness score is given by combining the collective liveness scores of the three models. This final liveness score is then received at the receiving unit [102].

Next at step [206] the method comprises receiving by the receiving unit [102] from the video processing system, a video liveness score. The video processing system generates the video liveness score based on a performance of a video-based liveness detection on the video of the subject/user. In an implementation the video of the user is validated based on one or more quality checks, one or more compliance checks and pre-processing of the video, for video liveness inference.

Continuing further, in an implementation the video is pre-processed to prepare an input, for the video processing system, to detect the video-based liveness. Further, the video processing system, to pre-process the video, may sample a plurality of consecutive frames from the video of the user. In a preferred implementation, the plurality of frames involves seventeen consecutive frames.

Continuing further, the video processing system may generate a set of optic flow images. The video processing system, to generate the set of optic flow images, may pair two consecutive frames from the plurality of frames (e.g., the seventeen consecutive frames). Further, the video processing system may run the paired frames on an optic flow model. In the above-mentioned preferred implementation, the set of optic flow images, generated by the video processing system, comprises sixteen images.

Also, generally the optical flow model is a computer vision technique that estimates the motion of objects (i.e., the subject in the present disclosure) in a video sequence. It involves analyzing the changes in intensity patterns of pixels over time to determine the direction and magnitude of object motion. Optical flow may be used in various applications such as video stabilization, object tracking, and action recognition. The optical flow model works by assuming that the movement of the object may be represented as a dense vector field, where each vector represents a displacement of a pixel from one frame to the next. An optical flow technique estimates this vector field by computing the displacement of pixels between adjacent frames.

Continuing further, the last “n” of the plurality of frames (e.g., in the above-mentioned preferred implementation last sixteen of the seventeen consecutive frames), along with the generated set of optic flow images (e.g., the sixteen optic flow images), are all resized to 224×224 for input to the video liveness model. It would be appreciated by a person skilled in the art that the pre-determined size is not limited to the 224×224 pixels, and its value may be considered depending on a use case.

The video liveness model comprises a multi-branch video liveness model. Continuing further, in the video liveness model, a set of consecutive RGB images (i.e., the last “n” of the plurality of frames) are used as an input for a first branch of the multi-branch video liveness model, while their corresponding optic flow images are used as an input for a second branch of the multi-branch video liveness model. Therefore, in the above preferred implementation, the sixteen consecutive RGB images are used as input for the first branch of the multi-branch video liveness model, while their corresponding optic flow images are used as an input for the second branch of the multi-branch video liveness model.

The multi-branch video liveness model thereafter generates the video liveness score based on a processing of the set of consecutive RGB images and the set of optic flow images. More specifically, for generating the video liveness score, the multi-branch video liveness model is trained to detect a movement of a target subject in a target video in an event of one of presence of a set of non-live attacks in said target video and an absence of the set of non-live attacks in said target video. The set of non-live attacks comprises at least one of the one or more display attacks, the one or more print attacks, and the one or more mask-based attacks. A person skilled in the art would appreciate that the set of non-live attacks as mentioned herein is not limited and any include other such similar type of attacks.

Further, the processing of the set of consecutive RGB images and the set of optic flow images comprises detecting a movement of the subject in the video. Further, the multi-branch video liveness model is further trained to generate a target video liveness score based on the movement of the target subject in the target video. Therefore, the multi-branch video liveness model initially processes the set of consecutive RGB images and the set of optic flow images to determine a movement of the subject based on the presence and/or absence of one or more non-live attacks. Once the movement of the subject is determined then the multi-branch video liveness model generates the video liveness score based on such determined movement. The generated video liveness score indicates the liveness or the non-liveness the subject, where the non-liveness of the subject indicates a fraudulent action on the video. This video liveness score is received at the receiving unit [102].

Further at step [208] the method comprises receiving by the receiving unit [102] from a sensor-data processing system, a sensor-based liveness score. The sensor-based liveness score is generated by the sensor-data processing system based on receiving a sensor data from a set of sensors for a predefined time duration. Further, the set of sensors may include, but not limited to, one or more accelerometer sensors and one or more gyroscope sensors. In an implementation, the sensor-data processing system may utilize the accelerometer sensor data (such as, but not limited to, data linear velocity of the electronic device, orientation of the electronic device, etc.) and the gyroscope sensor data (such as, but not limited to, data related to an angular velocity of the device, orientation of the device, etc.) to determine the liveness of the user. Further, in an implementation where the sensor-data processing system is configured along with the image processing system for liveness detection, the relative position and motion of the device may be used to distinguish between a live image(s) and a non-live image(s).

Once the sensor data is received a set of sanity checks are performed on the sensor data to generate a target sensor data. The target sensor data generated after performing the sanity check(s) on the sensor data may include a reliable, and an accurate data related to the orientation, movement and stability of the device. Considering an example, the accelerometer sensor data may include data related to the forward and/or backward movement of the device, whereas the gyroscope sensor data may include data related to the rotation of the device. The target data after the sanity check may include data that may focus on the subject and may remove any unwanted noise in the background.

Thereafter, the target sensor data is normalized to generate a normalized sensor data. The normalization of the target sensor data may include reorganizing the target sensor data and making it compatible to be utilized by the system [100]. For instance, the accelerometer sensor data and the gyroscope sensor data are normalized for easy processing. Furthermore, during the normalization of the target sensor data one or more anomalies and one or more extreme readings are removed.

Next, a set of data points are sampled from the normalized sensor data. In an implementation, the set of data points may include the last 250 sensor data logs, and the sensor data is logged approximately every ten milliseconds. Furthermore, in this implementation, the set of data points sampled may represent a recorded 2.5-3 seconds of sensor data, which is then provided as the input to a Convolutional Neural Network (CNN)-Long Short-Term Memory (LSTM) based model.

Therefore, the sampled set of data points are then provided to the Convolutional Neural Network (CNN)-Long Short-Term Memory (LSTM) based model. The CNN-LSTM based model then generates the sensor-based liveness score based on the sampled set of data points for classifying a specific subject as one of a live specific subject and a non-live specific subject based on a set threshold. The set threshold is a pre-configured threshold indicating a liveness or non-liveness of a specific subject, and its value may be based on a use case or a requirement. A sensor-based liveness score determined for a subject is therefore compared with a set threshold to determine liveness or non-liveness of said subject. The sensor-based liveness score generated by the sensor-data processing system is then received at the receiving unit [102].

Thereafter at step [210] the method comprises analyzing by the decision unit [104] the final image liveness score, the video liveness score, and the sensor-based liveness score. More specifically, the final image liveness score, the video liveness score, and the sensor-based liveness score are analyzed to determine a set of ensembling techniques that may be implemented to group at least two of the final image liveness score, the video liveness score, and the sensor-based liveness score. For example, an ensembling technique may include considering feature vectors corresponding to each of the final image liveness score, the video liveness score, and the sensor-based liveness score for combining these scores.

Thereafter, at step [212] the method comprises grouping by the decision unit [104] the final image liveness score, the video liveness score, and the sensor-based liveness score based on the analysis. For instance, the decision unit [104] determines a set of combinations of the final image liveness score, the video liveness score, and the sensor-based liveness score based on the set of ensembling techniques. The set of combinations indicates one or more combinations of these scores that may be considered for determining a set of liveness detection mechanisms.

Further at step [214] the method comprises identifying by the decision unit [104] the set of liveness detection mechanisms based on the grouping. The set of liveness detection mechanisms comprises at least one of a voting-based mechanism, a weighted average based mechanism, and an auxiliary network-based mechanism.

Thereafter at step [216] the method comprises determining by the determination unit [106] the liveness of the subject based on the set of liveness detection mechanisms.

The determining, by the determination unit [106], the liveness of the subject based on the voting-based mechanism comprises comparing, by the determination unit [106], the final image liveness score, the video liveness score, and the sensor-based liveness score with a corresponding pre-defined threshold score. After said comparison the method at this step comprises determining, by the determination unit [106], the subject as a live subject in an event each of the final image liveness score, the video liveness score, and the sensor-based liveness score is greater than the corresponding pre-defined threshold score. More specifically, in the voting-based mechanism, a user image is rejected as non-live if at least one of the liveness systems i.e., the image processing system, the video processing system, and the sensor-data processing system predicts the user image as a non-live image. Therefore, the voting-based mechanism is suitable for use cases where recall is critical.

Also, the determining, by the determination unit [106], the liveness of the subject based on the weighted average based mechanism comprises determining, by the determination unit [106], a final liveness score based on a weighted average of each of the final image liveness score, the video liveness score, and the sensor-based liveness score. After determining the final liveness score the method at this step comprises determining, by the determination unit [106], the subject as a live subject in an event the final liveness score is greater than a preset threshold score. More specifically, in the weighted average based mechanism, predicted liveness scores of the liveness systems i.e., the image processing system, the video processing system, and the sensor-data processing system are averaged to determine a final liveness score. The weighted average based mechanism therefore reduces the false rejection rate.

Moreover, the determining, by the determination unit [106], the liveness of the subject based on the auxiliary network-based mechanism comprises providing, by the decision unit [104] to a neural network-based model, at least one of the final image liveness score, the video liveness score, and the sensor-based liveness score. After providing these scores to the neural network-based model the method at this step comprises determining, by the neural network-based model, the subject as one of a live subject and a non-live subject based on at least one of the final image liveness score, the video liveness score, and the sensor-based liveness score. The neural network-based model is trained based on a set of final image liveness scores, a set of video liveness scores, and a set of sensor-based liveness score, to determine a target subject in a target video as one of a live target subject and a non-live target subject. Also, the neural network-based model is trained using one or more supervised learning techniques. More specifically, in the auxiliary network-based mechanism the neural network-based model is trained using a supervised learning on a set of feature vectors given out by the three liveness systems i.e., the image processing system, the video processing system, and the sensor-data processing system. The neural network-based model learns to identify exceptions, outliers, and general patterns to predict more robust and accurate liveness of the subject.

The method after determining the liveness of the subject then terminates at step [218].

Therefore, the present disclosure provides an efficient and effective solution for determining the liveness of the subject. The present disclosure overcomes the problem(s) associated with the known solutions by providing a solution of liveness detection that efficiently detects a fraudulent action. Also, the present solution provides a truly passive image data, video data and sensor data processing based liveness detection system to efficiently detect a fraudulent action. Additionally, the present solution provides a multi-processing (i.e., sensor data processing, video data processing, and image data processing) based passive liveness detection system that can be used on any device with a camera, such as mobile devices, computers, and edge devices, making it accessible and user-friendly for a broad range of users. Furthermore, the present disclosure provides a solution that uses data from various data sources, to determine liveness, resulting in a more robust and accurate detection system. The solution as provided in the present disclosure provides an easy-to-integrate SDK for input capture for liveness detection that further allows the existing developers to integrate the solution into their existing applications. Moreover, the present disclosure provides a solution that is compatible with a mobile or web application, providing a user-friendly interface for end-users to interact with the liveness detection system. Therefore, the present disclosure provides a solution that is technically advanced than the existing solution for liveness detection of the subject.

While the invention has been explained with respect to many examples, it will be appreciated by those skilled in the art that the invention is not restricted by these examples and many changes can be made to the embodiments disclosed herein without departing from the principles and scope of the present invention.

What is claimed is:

1. A method for determining liveness of a subject, the method comprising:
receiving by a receiving unit from an image processing system, a final image liveness score;
receiving by the receiving unit from a video processing system, a video liveness score;
receiving by the receiving unit from a sensor-data processing system, a sensor-based liveness score;
analyzing by a decision unit the final image liveness score, the video liveness score, and the sensor-based liveness score;
grouping by the decision unit the final image liveness score, the video liveness score, and the sensor-based liveness score based on the analysis;
identifying by the decision unit a set of liveness detection mechanisms based on the grouping; and
determining by a determination unit the liveness of the subject based on the set of liveness detection mechanisms.

2. The method as claimed in claim 1, wherein the sensor-based liveness score is generated by the sensor-data processing system based on:
receiving a sensor data from a set of sensors for a predefined time duration,
performing a set of sanity checks on the sensor data to generate a target sensor data,
normalizing the target sensor data to generate a normalized sensor data,
sampling a set of data points from the normalized sensor data,
providing the sampled set of data points to a Convolutional Neural Network (CNN)-Long Short-Term Memory (LSTM) based model, and
generating, by the CNN-LSTM based model, the sensor-based liveness score based on the sampled set of data points for classifying a specific subject as one of a live specific subject and a non-live specific subject based on a set threshold.

3. The method as claimed in claim 1, wherein the set of liveness detection mechanisms comprises at least one of a voting-based mechanism, a weighted average based mechanism, and an auxiliary network-based mechanism.

4. The method as claimed in claim 3, wherein the determining, by the determination unit, the liveness of the subject based on the voting-based mechanism comprises:
comparing, by the determination unit, the final image liveness score, the video liveness score, and the sensor-based liveness score with a corresponding pre-defined threshold score, and
determining, by the determination unit, the subject as a live subject in an event each of the final image liveness score, the video liveness score, and the sensor-based liveness score is greater than the corresponding pre-defined threshold score.

5. The method as claimed in claim 3, wherein the determining, by the determination unit, the liveness of the subject based on the weighted average based mechanism comprises:
determining, by the determination unit, a final liveness score based on a weighted average of each of the final image liveness score, the video liveness score, and the sensor-based liveness score, and
determining, by the determination unit, the subject as a live subject in an event the final liveness score is greater than a preset threshold score.

6. The method as claimed in claim 3, wherein the determining, by the determination unit, the liveness of the subject based on the auxiliary network-based mechanism comprises:
providing, by the decision unit to a neural network-based model, at least one of the final image liveness score, the video liveness score, and the sensor-based liveness score, and
determining, by the neural network-based model, the subject as one of a live subject and a non-live subject based on at least one of the final image liveness score, the video liveness score, and the sensor-based liveness score.

7. The method as claimed in claim 6, wherein the neural network-based model is trained based on a set of final image liveness scores, a set of video liveness scores, and a set of sensor-based liveness score, to determine a target subject in a target video as one of a live target subject and a non-live target subject.

8. The method as claimed in claim 6, wherein the neural network-based model is trained using one or more supervised learning techniques.

9. A system for determining liveness of a subject, the system comprising:
a receiving unit, configured to:
receive from an image processing system, a final image liveness score,
receive from a video processing system, a video liveness score, and
receive from a sensor-data processing system, a sensor-based liveness score;
a decision unit, configured to:
analyze the final image liveness score, the video liveness score, and the sensor-based liveness score,
group the final image liveness score, the video liveness score, and the sensor-based liveness score based on the analysis, and
identify, a set of liveness detection mechanisms based on the grouping; and
a determination unit, configured to determine the liveness of the subject based on the set of liveness detection mechanisms.

10. The system as claimed in claim 9, the sensor-data processing system is configured to generate the sensor-based liveness score based on:
a receipt of a sensor data from a set of sensors for a predefined time duration,
a performance of a set of sanity checks on the sensor data to generate a target sensor data,
a normalization of the target sensor data to generate a normalized sensor data,
sampling a set of data points from the normalized sensor data,
providing the sampled set of data points to a Convolutional Neural Network (CNN)-Long Short-Term Memory (LSTM) based model, and
a generation of the sensor-based liveness score by the CNN-LSTM based model, based on the sampled set of data points for classifying a specific subject as one of a live specific subject and a non-live specific subject based on a set threshold.

11. The system as claimed in claim 9, wherein the set of liveness detection mechanisms comprises at least one of a voting-based mechanism, a weighted average based mechanism, and an auxiliary network-based mechanism.

12. The system as claimed in claim 11, wherein the determination unit, to determine the liveness of the subject based on the voting-based mechanism, is configured to:
compare the final image liveness score, the video liveness score, and the sensor-based liveness score with a corresponding pre-defined threshold score, and
determine the subject as a live subject in an event each of the final image liveness score, the video liveness score, and the sensor-based liveness score is greater than the corresponding pre-defined threshold score.

13. The system as claimed in claim 11, wherein the determination unit, to determine the liveness of the subject based on the weighted average based mechanism, is configured to:
determine, a final liveness score based on a weighted average of each of the final image liveness score, the video liveness score, and the sensor-based liveness score, and
determine, the subject as a live subject in an event the final liveness score is greater than a preset threshold score.

14. The system as claimed in claim 11, wherein the determination unit, to determine the liveness of the subject based on the auxiliary network-based mechanism, is configured:
provide, to a neural network-based model, at least one of the final image liveness score, the video liveness score, and the sensor-based liveness score, and
determine, by the neural network-based model, the subject as one of a live subject and a non-live subject based on at least one of the final image liveness score, the video liveness score, and the sensor-based liveness score.

15. The system as claimed in claim 14, wherein the neural network-based model is trained based on a set of final image liveness scores, a set of video liveness scores, and a set of sensor-based liveness score, to determine a target subject in a target video as one of a live target subject and a non-live target subject.

16. The system as claimed in claim 14, wherein the neural network-based model is trained using one or more supervised learning techniques.
